(19) United States
(12) Patent Application Publication
(10) Pub. No.: US 2026/0110254 A1
(43) Pub. Date: Apr. 23, 2026

(54) ARCHITECTURE FOR A TURBOMACHINE GASKET

(71) Applicant: Safran Aircraft Engines, Paris (FR)

(72) Inventors: Jérôme Claude George LEMONNIER, Moissy-Cramayel (FR); Franck Davy Boisnault, Moissy-Cramayel (FR); Delphine Touchard, Moissy-Cramayel (FR); Jean-Marc Michel Lesaine, Moissy-Cramayel (FR)

(73) Assignee: Safran Aircraft Engines, Paris (FR)

(21) Appl. No.: 19/167,988

(22) PCT Filed: Mar. 20, 2024
(86) PCT No.: PCT/FR2024/050331

§ 371 Date: Sep. 23, 2025

(30) Foreign Application Priority Data
Mar. 23, 2023 (FR) FR2302737

(51) Int. Cl. F01D 11/08; B64D 27/10; F01D 25/12

(52) U.S. Cl. CPC F01D 11/08; F01D 25/12; B64D 27/10; F05D 2240/55

(57) ABSTRACT

A gasket configured to ensure a predefined clearance between the gasket and an outer surface, which includes a plurality of gasket sectors distributed circumferentially around the axis A, each gasket sector having an inner ring sector connected to an outer ring sector by a return member, where the radially inner surface of each inner ring sector includes at least one pattern hollowed out from the radially inner surface of the inner ring sectors, the inner ring sector further including at least one channel connecting a first opening which opens onto the upstream face of the inner ring sector and a second opening which opens into one of the patterns hollowed out from the radially inner surface of the inner ring sectors.

### TECHNICAL FIELD

This summary relates to sealing devices for aeronautical turbomachines and more precisely the architectures of such devices.

### PRIOR ART

The design of the ventilation circuits of an aeronautical turbomachine is complicated and constitutes a potential loss of performance.

Specifically, the turbomachine performs better when it operates at high temperature. However, its constituent materials then require more cooling. Cooling is generally done by drawing off part of the air from the cool air path, which has an adverse effect on the overall performance.

Moreover, the cooling circuit requires the production of a complex architecture to allow the cooling air to reach the blades to be cooled from the place at which it is drawn.

To make sure that the air circuit is not supplied with more cooling air than necessary, and thus does not overly hinder the performance of the turbomachine, labyrinth seals are generally disposed at the places from which the air is drawn.

Such seals make it possible to ensure the controlled passage of air at the places where they are disposed. The conventional architecture of labyrinth seals comprises lips disposed opposite abradable elements which have a recess structure of honeycomb type.

This type of seal does however have the disadvantage that the wear of the lips by friction against the abradable elements increases the clearance of the seal over the lifetime of the seal, and thus allows a greater passage of air, which ultimately leads to too much air being drawn and therefore to a loss of performance of the turbomachine.

Provision is sometimes made for alternatives to such labyrinth seals.

For example, provision is made for self-adjusting seals, sometimes known as hydrostatic seals in the literature.

Such seals make provision for forming a seal by disposing a main surface of the seal which comprises patterns opposite another surface, in rotation with respect to the main surface and separated therefrom by a predefined clearance.

It is understood that the sealing involved here is not a strict sealing in the sense of the air being unable to pass through the seal, but a relative sealing, the aim of the seal being to let through a definite amount of air, quantified by the predefined clearance.

The seal is known as self-adjusting, since the surface comprising the patterns interacts with the incident air stream such that:
if the clearance decreases, the pressure of the air between the surface of the seal and the opposite surface increases, such as to push back the seal and thus bring it back within the predefined clearance; and
if the clearance increases, the pressure of the air between the surface of the seal and the opposite surface decreases, such that a return element connected to the seal makes it possible to bring the seal back within the predefined clearance.

It should however be noted that the use of such seals is currently limited by the fact that the contact between the main surface of the seal and the opposite surface must be avoided under any circumstances, and in particular even during unusual, limit or accidental behavior.

The current functionality thus does not allow for the production of self-adjusting seals allowing a clearance smaller than half a millimeter, while self-adjusting seals are an enviable alternative to labyrinth seals, and this is why a need persists for such seals, which could be used with a smaller clearance than current self-adjusting seals.

Specifically, the behavior of such a self-adjusting seal, in particular its displacement, is conditional on the pressure difference between the upstream and the downstream of the seal.

However, in certain idle ratings of the turbomachine, in particular during the approach before landing, the pressure difference between the upstream and the downstream of the seal can be relatively small.

Moreover, the landing may cause a significant unbalance on the rotor shaft, and therefore a significant displacement of the surface opposite the seal.

In the presence of a small pressure difference between the upstream and the downstream combined with a significant displacement of the surface opposite the seal, it is possible that the inner surface of the seal will not be responsive enough to avoid coming into contact with the opposite surface.

A contact between the inner surface of the seal and the surface opposite the seal risks damaging the latter, and requiring the premature replacement thereof.

This admittedly unusual behavior must however be provided for in the dimensioning of the seal, and this is why it remains necessary to improve the behavior of the seal to be able to reduce the clearance thereof.

### SUMMARY OF THE INVENTION

The invention aims to meet this exact need. To do so it makes provision for a new architecture of a self-adjusting seal to improve the responsiveness thereof, in particular when the pressure difference between upstream and downstream of the seal is relatively small.

The invention relates, according to a first of its aspects, to a seal configured to ensure a predefined clearance between said seal and an outer surface of a rotor mounted rotatably about an axis A and disposed opposite the seal, the axis A defining an axial direction, the seal extending circumferentially around the axis A and comprising a plurality of seal sections circumferentially distributed around the axis A, each seal section comprising, radially with respect to the axis A, an inner ring section connected to an outer ring section by a return member,
the seal being characterized in that the radially inward surface of each inner ring section comprises at least one pattern hollowed out from the radially inward surface of the inner ring sections,
the inner ring section further comprising at least one channel connecting a first opening that opens onto the upstream face of the inner ring section and a second opening that opens into one of the patterns hollowed out from the radially inward surface of the inner ring sections.

Such an architecture of the seal differs radically from a labyrinth seal.

However the inner surface of the inner ring section does indeed ensure aerodynamic sealing while ensuring a predefined clearance with the opposite surface.

Moreover, the presence of the channel makes it possible to ensure a supply of air directly under the inner surface of the inner ring section of the seal. This additional air creates a large local overpressure at the at least one pattern, making it possible to increase the responsiveness of the seal.

In particular the presence of the channel makes it possible to ensure a pressure applied to the inner ring section at least 30% greater than that of a seal that is identical but without the channel.

The responsiveness of the seal being corelated with the pressure applied radially under the inner surface of the inner ring section, this overpressure does indeed give rise to a greater responsiveness of the seal.

Moreover, the presence of the channel makes it possible to lighten the whole device by approximately 10%. This mass saving is beneficial for the desired aeronautical application, but also because it causes an increase in the natural frequency of the seal, which reduces the risk of resonance phenomena appearing during use of such a seal.

In an embodiment, the axis A can be the main axis of a turbomachine.

In an embodiment, the radially inward surface of each inner ring section comprises a plurality of patterns repeated in the circumferential direction, and these patterns will be referred to as a row of patterns.

In an embodiment, each of the patterns has an elongate shape extending along an oblique direction with respect to the axial direction and being separated from another pattern by a non-hollowed-out portion of the inner surface.

In an embodiment, the radially inward surface of each inner ring section comprises at least two rows of patterns, each of the patterns having an elongate shape extending along an oblique direction with respect to the axial direction and being separated from another pattern by a non-hollowed-out portion of the inner surface.

The “circumferential distribution” of the seal sections is understood to mean that each seal section defines a portion of the circumference of the seal, and that together all the seal sections make it possible to obtain the full seal.

In an embodiment, the circumferential distribution is regular, and each seal section then represents an equal portion of the circumference of the seal.

It is understood that the predefined clearance is a “target” clearance, and that it is possible for the clearance to vary slightly around the predefined clearance value under operating conditions of the seal. When the seal is in its equilibrium position, the predefined clearance makes it possible to ensure that the air stream traversing the seal is the desired air stream. However, if the clearance increases or decreases, the whole seal will be brought to the predefined clearance by the spring behavior of the inner ring sections ensured by the return members or by the overpressure which then appears under the inner surface of the seal.

In general, the patterns present in the thickness of the inner surface of the inner ring section make it possible to improve the aerodynamic behavior of the seal.

The patterns hollowed out from the inner surface of the inner ring section moreover make it possible to modify the behavior of the seal, particularly by further increasing the pressure exerted by the air on the inner surface of the inner ring section when this latter approaches the opposite surface.

This makes contact between the inner surface of the inner ring section and the radially opposite surface even more improbable, thus reducing the risk of wear of the seal.

The patterns are referred to as “hollowed out from the inner surface of the inner ring section”, since it must be understood that the patterns form a relief in the radial direction of the ring section, i.e. the direction perpendicular to the axis A, and from the inner surface of the inner ring section.

The patterns have elongate shapes, for example parallelepipedal shapes. It is thus understood that the depth profile of the inner surface of the inner ring section defining a pattern is identical in the circumferential direction over a given distance, which will be arbitrarily referred to as the width of the pattern.

The second dimension of the pattern, in the plane of the inner surface of the inner ring section, will be arbitrarily referred to as the length.

One does not depart from the scope of the invention if the width is greater than the length but, for the sake of simplicity, in the remainder of the text only scenarios where a pattern is longer than it is wide will be described.

The dimensions are characterized as width and length for the sake of simplicity, but the invention is not restricted to the scenario in which the patterns are rectangular and does concern elongate patterns, and more precisely parallelepipedal ones.

Thus, and as described, the length of a pattern is in an oblique direction with respect to the axial direction.

The inclination quantifying the “oblique” characteristic of the patterns is understood to mean the angle defined between the direction in which the length of a pattern and the axial direction extends.

In an embodiment, the angle of inclination of each pattern with respect to the axial direction can be greater than or equal to 30°.

The angle of inclination of the patterns makes it possible, on the one hand, to contain more patterns or patterns of greater length on the surface of an inner ring section of given dimensions.

In an embodiment, the angle of inclination of the patterns is between 30° and 60°, or even between 30° and 45°.

Specifically, this makes it possible to moreover ensure that the air stream, which optionally has a tangential velocity due to the rotation of several elements with which it is optionally in contact, enters into the pattern without an excessive discontinuity being encountered.

Preferably, the angle of inclination is oriented in the same direction as the tangential velocity of the air stream, or else in the direction of rotation of the opposite surface with respect to the inner ring section.

The surface opposite the seal is a surface of a rotor mounted rotatably about the axis A, for example the rotor of a high-pressure turbine of an aeronautical turbomachine. In an embodiment, the patterns can be inclined in the same direction as the direction of rotation of the rotor.

This ensures that the orientation of the patterns is in the direction of the tangential velocity of the air traversing said patterns, which improves the overall performance of the seal.

As described, the inner ring section comprises at least one channel connecting a first opening disposed on the upstream face of the inner ring and a second opening on the inner face of the inner ring section, the second opening being disposed in one of the patterns.

In an embodiment, the radially inward surface of each inner ring section comprises at least two rows of patterns and the second opening is disposed in a pattern of the second row of patterns.

In an embodiment, the predefined clearance of the seal can be between 0.1 and 1.0 mm or between 0.5 mm and 1.0 mm.

This clearance is much smaller than those accessible for self-adjusting seals of the prior art, but the seal is nonetheless functional, particularly owing to the addition of the channel.

In an embodiment, the diameter of the channel increases between the first and the second opening.

In an embodiment, the first opening may comprise a diameter greater than or less than 0.5 mm.

In an embodiment, the first opening is radially disposed above a non-hollowed-out portion of the radially inward surface of the inner ring section. In other words, the first opening is radially disposed above a separation between two patterns of the first row of patterns.

It is understood that the first row of patterns is the first row encountered by the air stream passing the seal.

Thus, the first row of patterns can also be described as the “upstream row”, and the second row as the “downstream row”.

In an embodiment, a row of patterns may comprise more than five patterns, for example between 5 and 20 patterns, preferably between 7 and 15 patterns, or between 9 and 11 patterns.

In an embodiment, a given inner ring section comprises a plurality of channels. For example, the number of channels per inner ring section can be greater than or equal to 3. In other words, in an embodiment, several patterns of the second row comprise a second opening, or all the patterns have a second opening.

In an embodiment, all the channels present open into patterns of the second row of patterns.

In an embodiment in which the radially inward surface of each inner ring section comprises at least two rows of patterns, no channel opens into the first row of patterns.

In an embodiment in which the radially inward surface of each of the inner ring sections comprises a first and a second row of patterns, and in which each pattern of the second row of patterns is connected to at least one channel connecting a first opening that opens onto the upstream face of the inner ring section and a second opening that opens into the pattern.

Specifically, an embodiment with a single channel can suffice for the applied overpressure to be sufficient to improve the responsiveness of the seal. However, increasing the number of channels makes it possible to further improve the responsiveness of the seal and to uniformize the behavior thereof in the circumferential direction.

As described, the second opening makes it possible to ensure a radially local overpressure under the inner surface of the inner ring section of the seal. This generates a force on the surface of the seal directed from the rotating surface toward the inner surface of the inner ring section, i.e. it tends to make the clearance increase.

Since this force is applied locally, it can give rise to a behavior of the seal which is not uniform in its circumferential dimension. To uniformize the behavior thereof in the circumferential direction, the number of openings in this direction can be increased.

In an embodiment, the second opening or openings is or are symmetrically disposed in the circumferential direction of the seal.

This ensures a uniform behavior of the seal, or more precisely of the inner ring section in its circumferential direction.

In an embodiment, there are as many channels as there are patterns in the second row of patterns, each channel opening into a separate pattern of the second row.

In an embodiment, the patterns have a flat portion over which the depth does not vary, and it will be considered that the depth of this flat portion is the depth of the pattern. If the patterns do not have such a flat portion or if they have more than one flat portion, the depth of the pattern refers to the average depth of the pattern.

The depth of a pattern is understood to mean the distance between the inner surface of the non-hollowed-out inner ring section and the surface of the pattern, measured perpendicular to the surface of the inner ring section, i.e. along the radial direction.

The embodiments now described make it possible to ensure a faster return of the seal to its predefined clearance, and therefore to its equilibrium position.

Moreover, they ensure that the radially inward surface of the inner ring section does not come into contact with the opposite surface in the intended or even accidental operating modes.

In an embodiment, the patterns of the first row of patterns have a depth greater than or equal to the patterns of the second row of patterns.

In an embodiment, the radially inward surface of each of the inner ring sections comprises a first and a second row of patterns, and in which each pattern of the first row of patterns has a flat downstream area of constant and non-zero depth and an upstream pattern area in which the depth varies decreasingly while remaining greater than the constant depth of the downstream pattern area.

In this embodiment, the upstream area makes it possible to ensure a small pressure loss at the inlet of the seal. This makes it possible to improve the effectiveness of the seal overall.

In an embodiment, the upstream area of each pattern of the first row of patterns may have a rounded shape, i.e. a convex shape.

The downstream area plays the general role of the pattern which is to increase the pressure over the inner surface of the inner ring section when the clearance is smaller than the predefined clearance.

Moreover, since two patterns are separated by a non-hollowed-out portion of the inner surface of the inner ring section and the depth of the downstream part of the pattern of the first row is non-zero, this embodiment ensures that the air travelling through the first pattern encounters a wall directed in the radial direction at the end of the first pattern.

These walls ensure that the effort exerted by the air radially underneath the inner surface of the inner ring section is directed in the radial direction, and independently of its tangential velocity.

In an embodiment, the depth of the downstream part of the pattern of the first row can be between 1.5 times and 2.5 times the predefined clearance for the seal, for example between 0.1 mm and 1.0 mm.

The inventors have specifically observed that these depth values ensure an excellent distribution of the pressures in the seal, which improves the effectiveness thereof.

In an embodiment, at least one pattern of the second row of patterns has a flat downstream pattern area of constant and non-zero depth and an upstream pattern area in which the depth of the pattern varies increasingly from the inner surface of the inner ring section while remaining less than the constant depth of the downstream pattern area.

This embodiment makes it possible to ensure a new compression of the air entering into the pattern, providing an additional effort under the seal, and therefore better control of this latter in its return to the equilibrium position.

In an embodiment, the radially inward surface of each of the inner ring sections comprises a first and a second row of patterns, the patterns of the first row of patterns being offset in the circumferential direction with regard to the patterns of the second row of patterns.

For example, the patterns of the second row are offset in the circumferential direction with respect to the patterns of the first row by a distance between 0.25 times the width of a pattern and 0.75 times the width of a pattern, or even between 0.45 times the width of a pattern and 0.55 times the width of a pattern.

This embodiment makes it possible to ensure that the air stream traversing the seal and having a tangential velocity encounters many of the patterns of the two rows of patterns during its passage through the seal.

In an embodiment, the second openings may open into the upstream portion in which the depth of the pattern varies.

In an embodiment, the patterns of the second row of patterns which comprise a second opening may have a different geometry from that described above and/or from the first patterns.

In particular, in an embodiment, the patterns of the second row of patterns in which a second opening is present may have a different geometry from that of the patterns of the second row not comprising any second opening.

For example, in an embodiment the patterns of the second row in which a second opening is present may have a constant depth.

For example, the geometry may have a flared upstream portion, i.e. of increasing width, between the second opening and the downstream portion then a downstream portion of a constant width.

For example, the constant width can be identical to the width of the first patterns and/or to the width of the other patterns of the second row of patterns.

In an embodiment, the width of the downstream end of the patterns of the second row of patterns can be greater than or equal to 4 times the diameter of the second opening.

This embodiment makes it possible to ensure the air introduced into the second pattern works excellently to increase the responsiveness of the seal.

In an embodiment, the upstream portion of the patterns of the second row of patterns comprises a second flared opening which can be contained in a cone, the angle of which is between 10° and 45°, bounds included.

It is said that the flared upstream portion can be contained in a cone since it is not necessary for the flared portion to be straight provided that its width is increasing in the circumferential direction.

This embodiment makes it possible to ensure that the air provided via the channel directly to the pattern of the second row via the supply channel is indeed channeled into this pattern, which ensures a reduction in the load losses when air is introduced via this channel.

In an embodiment, the channel comprises an elbow bend forming an angle that can be between 60° and 90°.

Such an angle maximizes the impact of the introduced air on the responsiveness of the seal. In particular, this makes it possible to ensure that the air leaving the channel is directed toward the rotary surface facing the seal, which ensures the generation of a high local overpressure.

In an embodiment, the depth of the patterns of the second row can be less than or equal to 50% of the predefined clearance, for example between 30% and 50% of the predefined clearance.

In an embodiment, the outer ring sections form an outer shell and the inner ring sections have ends arranged end-to-end in the circumferential direction around the axis A.

In an embodiment, the circumferential ends of the inner ring sections have an angle of inclination with respect to the inner surface of the inner ring section between 30° and 90°.

This inclination of the ends of the inner ring sections of the seal sections makes it possible to ensure a displacement of the inner ring sections of the seal sections with respect to one another.

Specifically, during use, the radial displacement of the inner ring sections is not uniform. The inclination of the ends of the inner ring sections makes it possible to reduce the existing clearance between two inner ring sections, thus improving the effectiveness of the seal.

In an embodiment, the seal comprises between 8 and 12 seal sections.

For reasons of mechanical withstand, bulk and to ensure the flatness of the surface of the seals, it would be preferable to have as many sections as possible. On the other hand, for aerodynamic reasons, it is advisable to avoid leaks, and therefore to minimize the number of seal sections. The inventors have observed that such a number of seal sections was an optimal trade-off between these two opposing effects.

In an embodiment, the inner surface of the inner ring section may also comprise after the last pattern a non-hollowed-out surface of the inner surface of the inner ring section then a portion of increasing thickness between the non-hollowed-out surface and the downstream end of the inner ring section.

Such a profile makes it possible to reduce the heterogeneity of the pressure at the outlet of the seal, which reduces the risk of vibrational instability of the seal because of the wake of the air traversing it.

For example, the maximum depth of such a hollowed-out area can be of 0.2 mm.

In an embodiment, the outer ring sections of a seal can be made as a single part, for example a shell. In other words, there is no physical separation between two circumferentially successive outer ring sections.

In an embodiment, such a shell can be monolithic, i.e. made as a single part without connection. In such a scenario, it will be considered that an angular portion of the shell can be considered as an outer ring section.

In an embodiment, the seal further comprises a secondary sealing member radially disposed above the inner ring section such as to prevent the air from axially traversing the seal above the ring section.

Such a secondary sealing member makes it possible to ensure the sealing of the elements of the seal located radially above the inner ring section.

In other words, such a secondary sealing member ensures that the only path allowing the air upstream of the seal to cross it passes radially between the inner surface of the inner ring section and the outer surface opposite the seal.

Such a secondary member is known as such to those skilled in the art and may for example be chosen from among a brush seal, a set of tabs, or a tile.

According to another of its aspects, the invention also relates to a turbomachine comprising at least one seal as described above.

For example, at least one of the upstream inner seal (called “FIS” for “Forward Inner Seal”), of the upstream outer seal (called “FOS” for “Forward Outer Seal”) and/or of the first seal downstream of the high-pressure compressor (called “CDP” for “Compressor Discharge Pressure”) can be a seal as described above.

In an embodiment, the invention relates to an aeronautical turbomachine as described above, in which the at least one seal is disposed on a cooling air conveying circuit, said cooling air conveying circuit comprising an inlet drawing air downstream of the last disc of a high-pressure compressor and an inlet drawing in air downstream of the latter when a disc of a high-pressure compressor and an inlet drawing in air radially underneath a combustion chamber which takes the form of an air aperture opening into an air intake housing in communication with the cooling air conveying circuit and the seal being chosen from among:
an upstream seal located downstream of the high-pressure compressor traversed by the air drawn downstream of the last disc of the high-pressure compressor;
a downstream inner seal defining the inlet of said air intake housing and radially disposed under the air intake aperture; and/or
a downstream outer seal defining the outlet of said air intake housing and radially disposed under a high-pressure distributor.

### BRIEF DESCRIPTION OF THE DRAWINGS

FIG. 1 schematically represents a turbomachine.

FIG. 2 schematically represents a seal in an embodiment of the invention.

FIG. 3 schematically represents a seal in an embodiment of the invention along a different view from FIG. 2.

FIG. 4 schematically represents a seal in an embodiment of the invention along a different view from that of FIGS. 2 and 3.

FIG. 5 shows a seal comprising several seal sections, in an embodiment of the invention.

FIG. 6 shows a section view of a turbomachine equipped with seals as described according to an embodiment of the invention.

### DESCRIPTION OF THE EMBODIMENTS

The invention is now described by means of figures, present for descriptive purposes to illustrate certain embodiments of the invention and which must not be interpreted as limiting this latter.

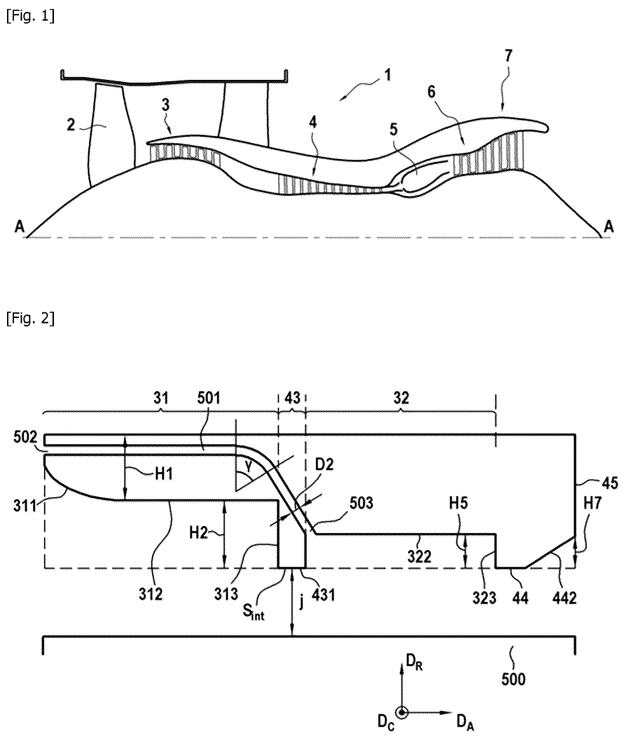

FIG. 1 shows, in section along a vertical plane passing through its main axis A, a bypass turbojet engine 1. It includes, from upstream to downstream along the circulation of the air stream, a fan 2, a low-pressure compressor 3, a high-pressure compressor 4, a combustion chamber 5, a high-pressure turbine 6, and a low-pressure turbine 7.

In this application, the relative positioning terms, for example “upstream”, “downstream”, “inner” and “outer” will be understood in relation to the horizontal axis A of the casing defining the axial direction, along the direction of flow of the main and secondary air streams of the turbomachine.

Thus, a so-called “upstream” element will be traversed before a so-called “downstream” element and a so-called “inner” element will be closer to the axis A than an “outer” element.

In this application, it is understood that the axial direction D_{A} is understood to mean the direction of the main axis A of the turbomachine; the circumferential direction D_{C} is that forming a circle around the axial direction D_{A}; and the radial direction D_{R}, defines a radius of the circle formed by the circumferential direction D_{C} and having as center the axial direction D_{A}.

FIG. 2 shows a profile view of an inner ring section.

FIG. 2 illustrates, in dotted lines, the outline of the non-hollowed-out inner ring section to better illustrate what is understood by the term “hollowed-out patterns” within the meaning of the invention.

As depicted in the figures, the inner surface Sᵢₙₜ of the ring section here comprises two rows of patterns 31, 32.

FIG. 2 describes the profile of the inner surface Sᵢₙₜ of the inner ring section as seen by the air traversing a pattern of the first row 31 then a pattern of the second row 32.

In other words, the FIG. 2 describes the depth profile along the width of the inner surface of the inner ring section 13 along the direction of the length of the patterns.

Within the meaning of the invention, the expression “the width of the inner surface of the inner ring section along the direction of the width of the patterns” is understood to describe the dimension of the inner surface Sᵢₙₜ of the inner ring section travelling in a direction offset from the axial direction D_{A} by an angle α equal to the inclination of the patterns.

It is here recalled that FIG. 2, like the other figures of this description, are neither to scale, nor even on the relative scale.

The figures are described at a scale that makes it possible to appraise their details but it is not possible to make the actual dimensions correspond thereto.

In the embodiment shown, the pattern 31 of the first row has an upstream area 311 in which the depth varies decreasingly and a flat downstream area 312 of non-zero constant depth H2.

On the embodiment shown, the upstream area 311 has a rounded shape, but this is not limiting of the invention.

The decrease in the depth could be constant, for example, the upstream area 311 then forming a gradient.

An upstream area 311 along which the depth decreases makes it possible to reduce the pressure loss at the inlet of the seal.

In an embodiment, the depth difference H1 between the radially upper end of the inner ring section and the downstream area 312 of the pattern 31 of the first row can be greater than or equal to 0.2 mm, for example between 0.2 mm and 4.0 mm.

In an embodiment, the depth H2 of the downstream area 312 of the pattern 31 of the first row can be between 1.5 times and 2.5 times the value of the predefined clearance j.

According to the desired application, the predefined clearance j will be between 0.10 mm and 0.45 mm.

There is no precise limit on the distribution between the upstream area 311 and the downstream area 312 of the pattern 31 of the first row.

For example, the upstream area 311 can be 10% and 20% of the length of the pattern 31 of the first row.

By symmetry, the downstream area 312 can account for between 80% and 90% of the length of the pattern 31 of the first row.

In an embodiment, the length of the pattern 31 of the first row can account for between 40% and 50% of the width of the inner surface of the inner ring section 13 along the direction of the length of the patterns.

Such a length of the pattern of the first row ensures excellent behavior of the seal and in particular ensures excellent behavior of the seal if this latter comes close to or moves away from its equilibrium position.

In an embodiment a pattern 31 of the first row can be spaced circumferentially apart from another pattern 31 of the first row, where applicable from the end of the inner ring section 13 by a non-hollowed-out space 41 by a length between 0.5 mm and 1.5 mm.

After the pattern 31 of the first row of patterns, and since the depth H2 of the first pattern is non-zero, and since this latter is separated from the pattern 32 of the second row of patterns by a non-hollowed-out portion 43 of the inner surface Sᵢₙₜ of the inner ring section 13 the pattern 31 of the first row of patterns comprises an end that has an abrupt variation 313 in the depth of the pattern.

This variation defines a vertical portion 313 which ensures the desired behavior for the seal.

In an embodiment, the length of the non-hollowed-out inner surface Sᵢₙₜ element 43 is less than 5% of the width of the inner surface of the inner ring section 13 along the direction of the length of the patterns.

In the embodiment shown on FIG. 2, the pattern 32 of the second row of patterns has a constant depth of the pattern H5.

In an embodiment, the length of the pattern 32 of the second row may account for between 40% and 50% of the width of the inner surface of the inner ring section 13 along the direction of the length of the patterns.

In an embodiment, after the pattern 32 of the second row of patterns, and since the depth H5 of the pattern 32 of the second row is non-zero, the pattern 32 of the second row can be circumferentially separated from the circumferential end of the inner ring section 13 by a non-hollowed-out portion 44 of the inner surface Sᵢₙₜ of the inner ring section 13.

Thus, the pattern 32 of the second row of patterns comprises an end which has an abrupt variation 323 in the depth of the pattern.

This abrupt variation defines a vertical portion 323 which ensures the desired behavior for the pattern 32 of the second row of patterns.

In an embodiment, the depth H5 of the pattern 32 of the second row can be less than or equal to 50% of the predefined clearance j, for example between 30% and 50% of the predefined clearance j.

In an embodiment a pattern 32 of the second row can be spaced apart from another pattern 32 of the second row, or where applicable from the edge of the end of the inner ring section 13 by a non-hollowed-out space 42 of a width between 0.5 mm and 1.5 mm.

In an embodiment, which is that shown on FIG. 2, the pattern 32 of the second row can be separated from the downstream of the inner surface Sᵢₙₜ by a non-hollowed-out surface portion 44 not belonging to a pattern.

In an embodiment, this non-hollowed-out surface portion 44 can itself be axially separated from the downstream edge 45 of the inner surface Sᵢₙₜ of the inner ring section 13 by a hollowed-out downstream area 442.

For example, the area 442 can have a linear variation in the depth, and this can be all the way to the downstream edge 45 of the inner ring section 13.

For example, the maximum depth H7 of the downstream area 442 can be greater than or equal to 0.2 mm.

Such a profile of the downstream area 442 of the inner ring section 13 makes it possible to ensure continuity of pressure.

In an embodiment, the length of the portion between the pattern 32 of the second row of patterns and the downstream edge 45 can be less than or equal to 10% of the width of the inner surface of the inner ring section 13 along the direction of the length of the patterns, or even between 6% and 10% of the width of the inner surface of the inner ring section 13 along the direction of the length of the patterns.

The invention is not limited by the relative size of the non-hollowed-out portion 44 and of the downstream area 442. Thus, the portion 44 may account for between 10% and 20% of the total length downstream of the second pattern, i.e. of the portions 44 and of the area 442.

By symmetry, the downstream area 442 may account for between 80% and 90% of the total area downstream of the second pattern, i.e. of the portions 44 and of the area 442.

In an embodiment, the width of the inner surface of the inner ring section 13 travelled in the axial direction can be between 20 mm and 40 mm.

For all intents and purposes, it is specified here that the width of the inner surface of the inner ring section 13 along the direction of the length of the patterns as defined above is then equal to the width of the inner surface of the inner ring section 13 travelled in the axial direction D_{A} divided by the cosine of the inclination α.

FIG. 2 further illustrates a channel 501.

This channel 501 comprises a first opening 502 and a second opening 503.

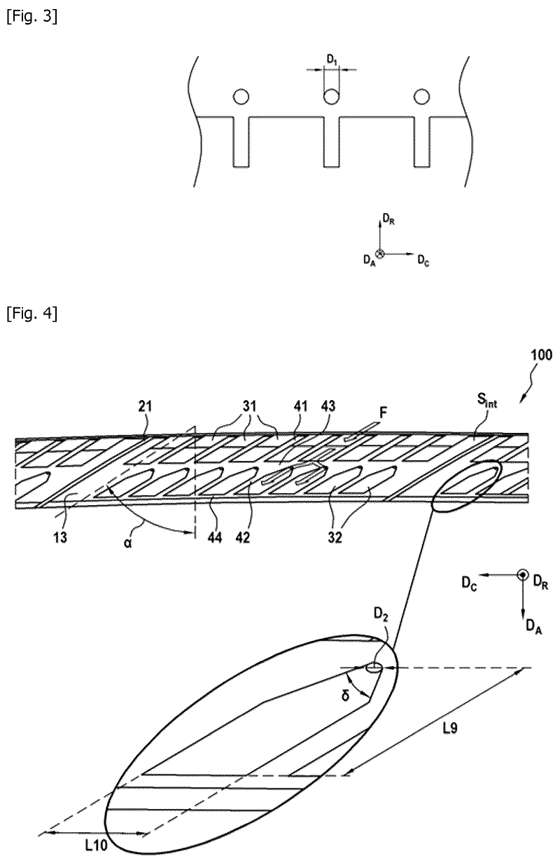

The first opening 502 is an opening on the upstream face of the inner ring section. This first opening 502 will be described more explicitly in relation to FIG. 3.

The channel 501 further comprises a second opening 503, which opens into the pattern 32 of the second row of patterns.

FIG. 2 further illustrates the angle γ of the elbow bend of the channel 501.

The angle γ of the elbow bend of the channel 501 is between 60° and 90°.

This embodiment makes it possible to ensure that the air coming from the channel is sent toward the surface 500 opposite the inner surface Sᵢₙₜ of the seal and that afterwards it allows it to meet the surface 500.

In an embodiment, the diameter of the channel 501 does not vary between its inlet diameter D1 and its outlet diameter D2.

In an embodiment, the diameter of the channel 501 may vary between its inlet diameter D1 and its outlet diameter D2.

In an embodiment, the diameter of the channel will widen, i.e. D1 will be smaller than D2.

In an embodiment, the inlet diameter D1 can be greater than or equal to 0.5 mm.

This is because the inventors have observed that such a diameter for the channel 501 allows it to exactly fulfil its function without compromising the structural integrity of the seal.

In an embodiment, the channel 501 is not necessarily spherical and can have an oval, or elliptical opening.

The term “inlet diameter D1” will nonetheless be used for the channel 501, considering the diameter of the circle, the surface of which would be equal to the surface of the inlet opening 502 of the channel.

In an embodiment, the same applies for the outlet opening 503 and similarly the term “outlet diameter D2” will be used for the channel 501 considering the diameter of the circle, the surface of which would be equal to the surface of the outlet opening 503 of the channel.

FIG. 3 schematically illustrates the upstream face of an inner ring section 13 as seen by the incoming air stream.

In the embodiment shown, the first openings 502 of the channels are radially disposed above non-hollowed-out portions 41 of the inner ring section 13. This embodiment makes it possible to ensure that a channel 501 opens above a pattern of the second row when this pattern is offset with respect to a pattern of the first row.

This is however not necessary to obtain the technical effect, and in an embodiment, the first openings 502 of the channels 501 can be radially disposed above first patterns, for example centered above the first patterns.

FIG. 4 illustrates the inner surface Sᵢₙₜ of an inner ring section as it can be in an embodiment of the invention.

FIG. 4 further comprises an inset representing a zoom on a pattern 32 of the second row of patterns.

As depicted on the figures, the patterns form two rows, an upstream row formed by the patterns 31 and a downstream row formed by the patterns 32.

In addition, each pattern is separated from the following one by a non-hollowed-out surface of the inner surface Sᵢₙₜ of the inner ring section 13, identified by the symbol 41 between two patterns 31 of the first row, by the symbol 42 between two patterns 32 of the second row, or else by the symbol 43 between a pattern 31 of the first row and 32 of the second row.

Furthermore, the patterns may or may not be spaced apart from the downstream edge of the inner ring section 13 by a non-hollowed-out space 44 of the inner surface Sᵢₙₜ of the inner ring section 13, not belonging to the pattern.

In an embodiment, the inner surface of the inner ring section 13 may comprise, between the non-hollowed-out space 44 and its downstream edge 45, a hollowed-out space 442.

Preferably, the space 44 between the pattern of the second row 32 and the downstream edge 45 comprises a non-hollowed-out portion 44 of the inner surface Sᵢₙₜ of the inner ring section 13, and a portion 442 forming a chamfer, i.e. the depth of which increases.

This embodiment makes it possible to reduce the pressure heterogeneity at the outlet of the seal.

As discussed above, the patterns are of elongate shape, and are oblique with respect to the axial direction D_{A}, i.e. presents with this direction an inclination a.

The air stream F is not aligned with the axial direction, but has a non-zero tangential velocity, which corresponds to that which it has in practice when the flat surface opposite the seal 400 is rotated in the circumferential direction D_{C}.

In an embodiment, the width of a pattern can be greater than or equal to 0.5 mm.

In an embodiment the width of a pattern can be between 0.5 and 5.0 mm or even between 2.0 mm and 5.0 mm.

Preferably, the width of a pattern 31 of the first row and the width L10 of a pattern 32 of the second row is identical.

In the scenario shown in which the width of a pattern varies, one may preferably consider that the width of the pattern is the width at the widest point of the pattern, for example the width of the downstream end of the pattern.

As depicted on FIG. 4, the first and second rows may not have the same number of patterns.

In an embodiment, the angle of inclination a is between 30° and 90°.

This inclination makes it possible to increase the length of the patterns hollowed out on the inner surface Sᵢₙₜ of the inner ring section 13.

It is shown on FIG. 4 that the patterns 32 of the second row are offset by one half-width approximately with respect to the patterns 31 of the first row.

Although the figures are neither to scale, nor even on the relative scale, in an embodiment the patterns 32 of the second row are effectively offset with respect to the patterns 31 of the first row, for example by one pattern half-width approximately.

This offset makes it possible to ensure that the air diverted by a pattern 31 of the first row of patterns then passes through a pattern 32 of the second row of patterns.

The path taken by the air stream F passing through the patterns is depicted by arrows on FIG. 4.

As described above, the length L9 of the pattern 32 of the second row can account for between 40% and 50% of the width of the inner surface Sᵢₙₜ of the inner ring section 13 along the direction of the length of the patterns.

The inset of FIG. 4 also makes it possible to depict the angle δ of the upstream portion of the pattern 32 of the second row of patterns.

FIG. 4 finally depicts what is understood by the width of the pattern 32 of the second row of patterns and this latter is identified by the length L10.

In an embodiment L10 can be less than or equal to four times D2, for example less than or equal to 5.0 mm, for example between 2.0 and 5.0 mm.

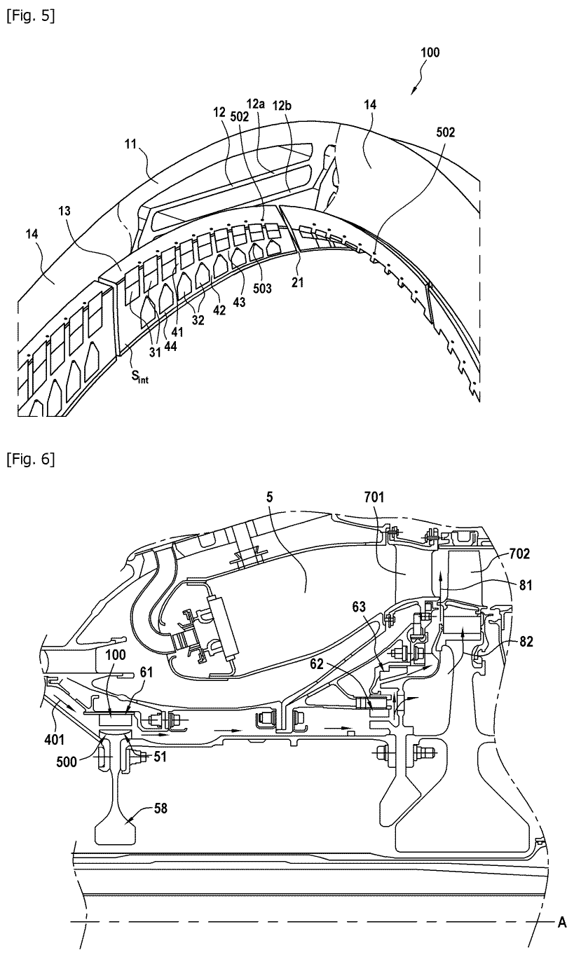

FIG. 5 describes a seal which comprises several seal sections. As illustrated, the outer ring section 11 can be shared by several sections of the seal, or even to all the sections of the seal.

For reasons of representation, the outer surface opposite the seal is not shown on FIG. 5.

In an embodiment and as can be seen on FIG. 5, all the seal sections, and more precisely the inner and outer ring sections makes it possible to give the entire seal an annular shape.

FIG. 5 also depicts the circumferential space between two seal sections 21, and shows that the return member 12 may comprise an outer arm 12a and an inner arm 12b.

FIG. 5 further illustrates a secondary sealing member 14 as described above. The secondary sealing member may comprise a plurality of circumferentially distributed elements.

Although the representation of the secondary sealing member 14 is truncated on FIG. 5 to make the elements 11 and 12 visible, the secondary sealing member 14 may cover the entire circumference of a seal as described above.

For example, there can be as many, more or fewer portions of secondary sealing member as there are sealing member sections.

Furthermore, FIG. 5 illustrates the first openings 502 and second openings 503 of the channels, visible here respectively on the upstream face of the inner ring sections 13, and on the inner surface Sᵢₙₜ of the inner ring sections.

FIG. 6 represents a portion of the turbomachine visible on FIG. 1, and illustrates that this latter can be equipped with seals in accordance with those described above.

In the embodiment shown, the turbomachine portion has three seals: an upstream inner seal 62 (“FIS”), an upstream outer seal 63 (FOS) and a first seal downstream of the high-pressure compressor 61 (“CDP”).

Such seals are now described in relation with FIG. 6 which is only an example of a configuration for an air cooling path in a turbomachine, and those skilled in the art will be able to identify an upstream outer seal 63 (“FOS”), an upstream inner seal 62 (“FOS”) and a first seal downstream of the high-pressure compressor 61 (“CDP”) in other geometries of the cooling circuit.

FIG. 6 shows a diagram of a cooling circuit of a turbomachine.

In the embodiment shown, air is drawn downstream of the last compressor disc 401 as well as below the combustion chamber 5.

The air drawn downstream of the last compressor disc 401 first traverses the seal 61, which is radially located under the inlet of the combustion chamber 5.

The seal 61 defines the amount of air for the cooling circuit 401 drawn downstream of the last disc of the high-pressure compressor 4.

The air drawn below the combustion chamber can for example be drawn via an air aperture, opening into a housing included between the upstream outer seal 63 and the upstream inner seal 62.

On FIG. 6, these two seals respectively delimit the inlet and outlet of such a housing.

The seal 62 is traversed by the air coming from the high-pressure compressor 401 wishing to enter this housing, and this is the case whether it is then used by the cooling circuit 82 or whether it is intended for the bleed circuit 81.

The seal 63 itself delimits the outlet of the air intake housing, and limits the air stream rejoining the bleed circuit 81.

For example, the seal 62 can be radially located under the air intake aperture, while the seal 63 can be located under the first distributor of the high-pressure turbine 701.

On FIG. 6, the bleed circuit opens between the high-pressure distributor 701 and the first high-pressure rotor blade 702.

In the embodiment shown, it will be noted that the surface opposite the seals 62 and 63 is an outer surface of a stage of the rotor of the high-pressure turbine.

FIG. 6 shows a turbomachine for which the three particular seals 61, 62, 63 are as described above, but one does not depart from the scope of the invention if only one of these seals is as described above.

In the remainder of the text, the seal 61 will be described, but it should be noted that what is described for this seal is also applicable to the other seals.

In an embodiment, which is the one shown, the surface 500 opposite the seal comprises a groove filled with a resin 51.

This embodiment makes it possible to ensure that under abnormal operation, and if it were to come into contact with the surface opposite the seal, the inner surface of the seal would not damage the surface 500 itself, but only the resin 51.

Moreover, the resin 51 can be transparent, which then allows an even easier control insofar as the surface 500 is visible under the resin and it is possible to visually observe, without having to remove the resin, whether or not the use of the seal has caused any deterioration of the surface 500 opposite.

In an embodiment, the surface 500 opposite the seal, whether or not it is equipped with a groove and resin 51, can be in connection with a flyweight 58.

This embodiment ensures that the surface opposite the seal 500 remains flat throughout the operation of the seal and minimizes the risk of the inner ring section 13 of the seal 100 coming into contact with the surface 500 opposite.

On FIG. 6, the air stream traversing the seals is depicted by arrows, and the axis A of the turbomachine is also present.

FIG. 6 shows how the air 401 drawn at the outlet of the high-pressure compressor 4 can reach a movable blade 702 of the hot part of the turbomachine, here of the high-pressure turbine 6, disposed after the combustion chamber 5. In an alternative mode, the air can also go back out of the cooling circuit via the bleed outlet 81, after traversing the upstream inner 62 and upstream outer 63 seals.

A part of the cooling air passes via the path 82 to be injected directly in the cooling circuit of a movable blade 702 of the hot part of the turbomachine, here a movable blade 702 of the high-pressure turbine.

The bleed outlet of the cooling circuit is here located between a fixed blade 701 and a movable blade 702 of the high-pressure turbine 6.

FIG. 6 also illustrates that the surface 500 opposite the seal can be a surface of a rotor mounted rotatably about the axis A. For example, the surface 500 can be a surface of the rotor of the high-pressure turbine 6.

1. A seal configured to ensure a predefined clearance between said seal and an outer surface of a rotor mounted rotatably about an axis A and disposed opposite the seal, the axis A defining an axial direction, the seal extending circumferentially around the axis A and comprising a plurality of seal sections circumferentially distributed around the axis A, each seal section comprising, radially with respect to the axis A, an inner ring section connected to an outer ring section by a return member the seal being characterized in that the radially inward surface of each inner ring section comprises at least one pattern hollowed out from the radially inward surface of the inner ring sections, the inner ring section further comprising at least one channel connecting a first opening that opens onto the upstream face of the inner ring section and a second opening that opens into one of the patterns hollowed out from the radially inward surface of the inner ring sections.

2. The seal as claimed in claim 1, wherein the radially inward surface of each inner ring section comprises at least two rows of patterns, each of the patterns having an elongate shape extending along an oblique direction with respect to the axial direction and being separated from another pattern by a non-hollowed-out portion of the inner surface.

3. The seal as claimed in claim 1, wherein the angle of inclination of each pattern with respect to the axial direction is greater than or equal to 30°.

4. The seal as claimed in claim 1, wherein the diameter of the channel increases between the first and the second opening.

5. The seal as claimed in claim 2, wherein the radially inward surface of each of the inner ring sections comprises a first and a second row of patterns, and wherein each pattern of the first row of patterns has a flat downstream area of constant and non-zero depth and an upstream pattern area in which the depth varies decreasingly while remaining greater than the constant depth of the downstream pattern area.

6. The seal as claimed in claim 2, wherein the radially inward surface of each of the inner ring sections comprises a first and a second row of patterns, the patterns of the first row of patterns being offset in the circumferential direction with regard to the patterns of the second row of patterns.

7. The seal as claimed in claim 2, wherein the radially inward surface of each of the inner ring sections comprises a first and a second row of patterns, and wherein each pattern of the second row of patterns is connected to at least one channel connecting a first opening that opens onto the upstream face of the inner ring section and a second opening that opens into the pattern.

8. The seal as claimed in claim 2, wherein the radially inward surface of each of the inner ring sections comprises a first and a second row of patterns and wherein the width of the downstream end of the patterns of the second row of patterns is greater than or equal to 4 times the diameter of the second opening.

9. The seal as claimed in claim 2, wherein the radially inward surface of each of the inner ring sections comprises a first and a second row of patterns and wherein the patterns of the second row of patterns comprising a second opening have a flared upstream portion contained in a cone, the angle of which is between 10° and 45°.

10. The seal as claimed in claim 1, wherein the channel comprises an elbow bend forming an angle between 60° and 90°.

11. A turbomachine comprising at least one seal as claimed in claim 1.

12. An aeronautical turbomachine wherein at least one seal as claimed in claim 1 is disposed on a cooling air conveying circuit, said cooling air conveying circuit comprising an inlet drawing air downstream of the last disc of a high-pressure compressor and an inlet drawing in air radially underneath a combustion chamber which takes the form of an air aperture opening into an air intake housing in communication with the cooling air conveying circuit and the seal being chosen from among:
an upstream seal located downstream of the high-pressure compressor traversed by the air drawn downstream of the last disc of the high-pressure compressor;
a downstream inner seal defining the inlet of said air intake housing and radially disposed under the air intake aperture; and/or
a downstream outer seal defining the outlet of said air intake housing and radially disposed under a high-pressure distributor.
